(19) United States
(12) Patent Application Publication
(10) Pub. No.: US 2025/0170530 A1
(43) Pub. Date: May 29, 2025

(54) METHOD FOR PREPARING LOOSE CROSS-SECTIONAL ASYMMETRIC ISOPOROUS MEMBRANE BASED ON THERMALLY INDUCED PHASE SEPARATION PROCESS

(71) Applicant: Zhejiang University of Technology, Hangzhou (CN)

(72) Inventors: Zhuan YI, Hangzhou (CN); Fengjie YIN, Hangzhou (CN); Tao WU, Hangzhou (CN)

(21) Appl. No.: 18/956,014

(22) Filed: Nov. 22, 2024

(30) Foreign Application Priority Data
Nov. 23, 2023 (CN) 202311568442.1

(51) Int. Cl. B01D 69/02; B01D 67/00; B01D 71/80

(52) U.S. Cl. CPC B01D 69/02; B01D 67/0011; B01D 71/80; B01D 2325/0212; B01D 2325/022

(57) ABSTRACT

A method for preparing an asymmetric isoporous membrane with loose cross-section based on a thermally induced phase separation process, and an asymmetric isoporous membrane prepared provided. The prepared isoporous membrane show loose cross-section, high permeability, and high strength, and the fabricating process used recyclable and non-toxic dilutes as the solvents.

### CROSS-REFERENCE TO RELATED APPLICATIONS

The present application claims priority to Chinese Patent Application No. 202311568442.1, filed on Nov. 23, 2023, which is hereby incorporated by reference in its entirety.

### TECHNICAL FIELD

The present disclosure relates to the field of polymer separation membrane material, in particular to a method for preparing a loose cross-sectional asymmetric isoporous membrane based on a thermally induced phase separation process.

### BACKGROUND

The membrane separation plays important roles in many fields, such as environmental remediation, water treatment, resource recovery, molecular separation, and the like in recent years due to their outstanding advantages including the high energy efficiency, ecofriendliness, low cost, wide applicability, and so on. The isoporous membrane refers to those membranes with uniform pore diameters and consistent pore shapes in whole separation layer. The isoporous membrane exhibits the characteristics of uniform pore size and narrow pore size distribution, thus, compared with other porous membrane materials with broad pore size distribution, it is able to overcome the trade-off effects between the permeability and selectivity, so as to realize a simultaneous improvement on the selectivity and permeability.

In recent years, the preparation method of isoporous membrane mainly includes anodic oxidation, template synthesis, nuclear track etching, micro-nano processing, block copolymer microphase separation, and the like. Considering the availability of membrane forming material, the comprehensive separation performances, as well as the compatibility with existing preparation scale, the latest method for preparing the isoporous membrane usually adopts the amphiphilic block copolymers as raw materials for their unique self-assembly characteristics. Currently, the most widely used method for preparing asymmetric isoporous membrane is the combination of block copolymer self-assembly with the non-solvent-induced phase separation, which is known as the SNIPS approach. The combination of block copolymer self-assembly with the non-solvent-induced phase separation, namely, the SNIPS has the advantages of simple operation process, good pore regularity and poor ordering, and the like. However, the numerous conditions and lots of variable factors, such as temperature and humidity, evaporation time, solution concentration for membrane casting, solvent properties, conditions of non-solvent, and many others, required to be carefully controlled during the SNIPS process to ensure the smooth generation of isoporous structure from membrane casting solution. Meanwhile, the asymmetric isoporous membrane prepared the SNIPS usually display a dense and compact cross-section which shows a large flow resistance and low permeability. As a result, it remains challenge to achieve both high flux and high selectivity for these membranes. At the same time, most of the solvents used for preparing the block copolymer isoporous membrane by the SNIPS are toxic, which would generate a large amount of waste water containing a high concentration of organic solvent. Therefore, there is an urgent need for a new green manufacturing method for preparing the asymmetrical isoporous membrane with loose cross-section and large flux by using green solvent systems.

### SUMMARY

Regarding the defects of the prior art, the present disclosure provides a method for preparing a loose cross-sectional asymmetric isoporous membrane based on a thermally induced phase separation process, using a bio-based green solvent which leads to the characteristics of forming clear and homogenous liquid phase at high-temperature and solid phase at low-temperature for membrane casting solution containing the block copolymer, making the membrane casting solution show phase homogeneity at high-temperature and phase separation at low-temperature, and the membrane casting parameters are regulated according to the upper critical solution temperature of the casting solution system, to obtain an asymmetric isoporous membrane with loose cross-section, good permeability, and high strength. In addition, the method realizes recycling of the solvent, which will largely decrease the amount of solvent-containing waste liquid in the preparation process, and has the characteristic of environmental friendliness.

In some embodiments, a technical solution provided includes:
a method for preparing a loose cross-sectional asymmetric isoporous membrane based on a thermally induced phase separation process, including the following steps:
S1: stirring a block copolymer, a diluent, and a pore-forming agent at 40° C. to 185° C. to form a homogeneous membrane casting solution. The selected temperature is above melting point and below boiling point of the diluent, and in which the block copolymer and the pore-forming agent are completely dissolved and have a suitable viscosity required for spreading. In addition, the block copolymer solution is in a macroscopic homogeneous state within this temperature range and has thermally stable properties. When at a temperature lower than this temperature range, the diluent is in a solid state and has no ability to dissolve the polymer, or even if a solution is formed, the solution has an extremely high viscosity and has no condition to forming membrane by spreading. When at a temperature higher than this temperature range, evaporation rate of dilute become too fast, which will reduce the time for assembly of block polymer and isopores cannot be formed. Also, the differences on evaporation rate of diluents from casting solution will increase, which tends to cause relative changes of solvent contents in the solution, and is difficult to ensure structure stability and reproducibility of the formed membrane.

The block copolymer includes a hydrophobic chain segment and a hydrophilic chain segment, the hydrophobic chain segment is polystyrene, and the hydrophilic chain segment is a water-soluble polymer or a polymer formed by polymerizing a water-soluble monomer. The diluent is cyclohexanol and/or an ethylene glycol derivative. The membrane casting solution is phase homogenous at high-temperature and undergoes phase separation at low-temperature, or is phase homogenous at high-temperature and gelates at low-temperature.
S2: preheating a porous cloth or a metal plate to set temperature, evenly spreading the membrane casting solution on the porous cloth or the metal plate, and evaporating the spreaded solution at 40° C. to 150° C. for 5 s to 45 s, and transferring into a coolant for cooling and gelling. Keeping the membrane casting solution in a homogeneous liquid state within this temperature range, and combining with a controlled evaporation time will promote the block copolymer to assemble into isopores. When the evaporation time is shorter, the assembly is insufficient, and it is difficult to form an isoporous structure on surface. When the evaporation time is longer, the polymer concentration in the membrane is too high, and concentration gradient on cross-section is reduced, which is not conducive to form a loose cross-section with a gradient porous structure.
S3: immersing a cooled and gelled membrane into an extracting agent for extraction, and transferring into deionized water for soaking and cleaning, to obtain the asymmetric isoporous membrane.

In some embodiments, the diluent is any one or a combination of two of cyclohexanol, 1-methyl-cyclohexanol, 2-methyl-cyclohexanol, 3-methyl-cyclohexanol, 4-methyl-cyclohexanol, 4-ethyl-cyclohexanol, 1,2-cyclohexanediol, 1,3-cyclohexanediol, 1,4-cyclohexanediol, 4,4′-bicyclohexanol, ethylene glycol monobutyl ether, and ethylene glycol monomethyl ether. In some embodiments, the diluent is any one or a combination of two of 1-methyl-cyclohexanol, 1,2-cyclohexanediol, 1,3-cyclohexanediol, and 1,4-cyclohexanediol. These diluents enable the generation of isoporous membranes with much loose cross-sections and show better membrane forming effect.

In some embodiments, when the diluent is a combination of cyclohexanol and 1,2-cyclohexanediol, or a combination of cyclohexanol and 1,3-cyclohexanediol, or a combination of cyclohexanol and 1,4-cyclohexanediol, or a combination of 1-methyl-cyclohexanol and 1,2-cyclohexanediol, or a combination of 1-methyl-cyclohexanol and 1,3-cyclohexanediol, or a combination of 1-methyl-cyclohexanol and 1,4-cyclohexanediol, the 1,2-cyclohexanediol or 1,3-cyclohexanediol or 1,4-cyclohexanediol accounts a proportion of no less than 15 wt % in the diluent. According to experimental results, when the cyclohexanediol accounts a content of lower than 15%, the obtained asymmetric isoporous membrane has a dense cross-section and a low porosity, where the cyclohexanediol includes: 1,2-cyclohexanediol, 1,3-cyclohexanediol, and 1,4-cyclohexanediol.

In some embodiments, the pore-forming agent is any one of adipic acid, succinic acid, citric acid, copper acetate, zinc acetate, magnesium sulfate, cyclodextrin, and polyethylene glycol. The functional groups such as carboxylic acid, or the metal ions in the selected pore-forming agent coordinates with hydrophilic chain segments or interact by hydrogen bonds, which will promote the self-assembly of the block copolymer to form an isoporous structure on surface.

In some embodiments, the coolant is any one of air, water, silicon oil, glycerin, and polyethylene glycol having a molecular weight of no more than 1000 Da. The selected coolant is non-toxic, easily controlled in temperature, and not miscible with the membrane casting solution. The coolant has a temperature range of −15° C. to 90° C. When the temperature is lower than the lower limit temperature, the membrane casting solutions gelate and solidify rapidly, phase separation cannot be sufficiently performed, and it will not facilitate the formation of a loose cross-sectional structure with isoporous surface, and the formed membrane also has many defects. When the temperature is higher than the upper limit temperature of 90° C., the membrane casting solution show an incomplete phase separation that will lead to structure collapse on extracting in extracting agent.

In some embodiments, the extracting agent is any one or a combination of two of isopropanol, acetone, methanol, ethanol, and petroleum ether. The selected extracting agent is immiscible with the diluent, but cannot dissolve the block copolymer, and is easy to be recovered and recycled by reduced pressure distillation.

In some embodiments, the block copolymer accounts a mass concentration of 5 wt % to 35 wt % in the membrane casting solution. In this concentration range, the block copolymer undergoes the micellization and microphase separation smoothly in casting solution, eliminating the possibility that the block copolymer cannot assemble into pores due to a too low concentration. When the concentration is higher than the upper limit concentration, the viscosity is too large, and it is difficult to form membrane by spreading.

In some embodiments, in S2, evenly spreading the membrane casting solution on the porous cloth or the metal plate to a thickness range of 50 μm to 300 μm. In this thickness range, defects caused by spreading are better eliminated, and an asymmetric membrane with a loose cross-section is obtained. When less than this thickness range, the cross-section of the membrane is too dense and tends to generate defects. When greater than this thickness range, it will take too much casting solution and lots of block copolymer is consumed. Also, the membrane thickness is too high to have a large permeation flux. The porous cloth is polyester non-woven fabric or polyolefin non-woven fabric. The selected non-woven fabric has high strength, good flexibility, and resistant to corrosion. The membrane casting solution has a good membrane forming effect and a proper thickness on the above two non-woven fabrics.

An asymmetric isoporous membrane prepared according to any one preparation method provided. The obtained asymmetric porous membrane has a cross-section with permeable transport, without defects. The “without defects” refers to that the prepared asymmetric isoporous membrane has flat surface, uniform pore size, domain spacing of the pore phase on surface corresponding to that of the assembled phase in block copolymer, and no pinhole or non-assembled hole.

The present disclosure has the following beneficial effects:
(1) according to the present disclosure, the asymmetric isoporous membrane is prepared through block copolymer assembly and phase separation induced by controlled cooling, with fewer influence parameters during the membrane forming process, showing high universality, and wide applicability. The prepared isoporous membrane has loose cross-section, good permeability, ordered arrangement of surface isoporous structure, and a high porosity. In comparison with isoporous membrane prepared through block copolymer self-assembly combined with non-solvent-induced phase separation (SNIPS), it show obviously improved permeability while remaining similar selectivity.
(2) According to the method for preparing the isoporous membrane of the present disclosure, a bio-based green solvents is adopted as a diluent. In addition, a mixed solution of the diluent and the extracting agent is subjected to reduced pressure distillation to realize separation and recycle of them, involving a characteristics of cycle economy. The membrane preparation process has the advantages of being green and environment-friendly, low wastes discharge, and low toxicity, and has important value for promoting large-scale preparation and application of the porous membrane.

### BRIEF DESCRIPTION OF DRAWINGS

FIG. 1 is a schematic diagram of a device used for the membrane forming process according to an embodiment of the present disclosure.

FIG. 2 is a state diagram of the membrane casting solution at different temperatures in Example 1 of the present disclosure, where (a) the membrane casting solution at 160° C., (b) the membrane casting solution at 100° C., (c) the membrane casting solution at 50° C., and (d) the membrane casting solution at room temperature.

FIG. 3 is a water flux comparison diagram of the isoporous membrane prepared by Example 1 of the present disclosure and the membrane prepared by the block copolymer self-assembly combined with non-solvent-induced phase separation (referred as the SNIPS) using the same block copolymer.

FIG. 4 is an infrared spectrum of the membrane casting solution and the isoporous membrane prepared in Example 1 of the present disclosure.

FIG. 5 is an electron micrographs of the surface and the cross-section of the isoporous membrane prepared in each Examples of the present disclosure, where (a) the scanning electron micrographs of Examples 1 to 4, and (b) the scanning electron micrographs of Examples 5 to 7 and the membrane produced by the SNIPS.

### DESCRIPTION OF EMBODIMENTS

The present disclosure will be described in detail below with reference to the accompanying drawings and preferred examples, and the objects and effects of the present disclosure will be clearer. It should be understood that specific examples described herein are intended only to interpret the present disclosure and not to limit the present disclosure.

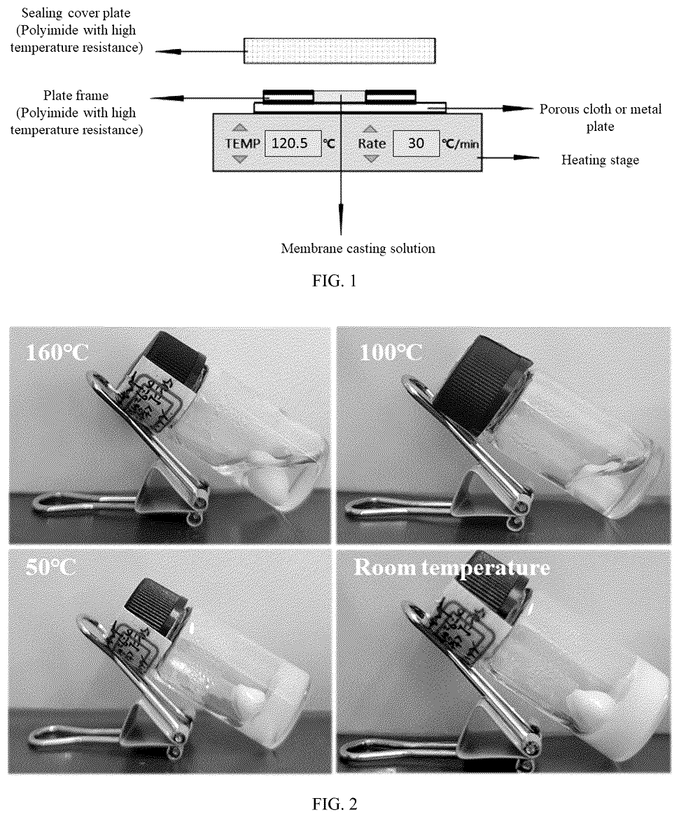

A method for preparing a loose cross-sectional asymmetric isoporous membrane based on a thermally induced phase separation process, including the following steps:
S1: stirring a block copolymer, a diluent, and a pore-forming agent at 40° C. to 185° C. to form a homogeneous membrane casting solution;
S2: as shown in FIG. 1, placing a porous cloth or a metal plate on a heating stage for heating the porous cloth or the metal plate to a required temperature, evenly spreading the membrane casting solution on the porous cloth or the metal plate, and evaporating at 40° C. to 150° C. for 5 s to 45 s and sealing with a sealing cover plate to obtain a scaling unit, and transferring into a coolant for cooling and gelling, where there is a plate frame fixed on the porous cloth or the metal plate for limiting the membrane forming size, a material for the plate frame is polyimide or polyethylene with high temperature resistance, and a material for the sealing cover plate is polyimide with high temperature resistance; and
S3: taking a cooled and gelled membrane from the sealing unit and immersing into an extracting agent for extraction, and transferring into deionized water for soaking and cleaning, to obtain the asymmetric isoporous membrane.

After the preparation of the asymmetric isoporous membrane, a mixed solution containing the diluent and the extracting agent is subjected to reduced pressure distillation to realize separation and recycle of the diluent and the extracting agent.

The method for preparing a loose cross-sectional asymmetric isoporous membrane based on thermally induced phase separation process according to the present disclosure can be implemented on the equipment and production line for preparing polyvinylidene fluoride and other porous membranes based on the thermally induced phase separation process, without a great modification on the production line and equipment.

The polymer, the diluent, the coolant, and the extracting agent herein are also suitable for preparing asymmetric hollow fiber isoporous membranes with different forms, especially with loose cross-section.

The present disclosure will be described in detail below through several examples.

### Example 1

S1: polystyrene-block-poly (4-vinylpyridine) having a molecular weight of 83,000 g/mol was selected as the membrane forming block copolymer, where the polystyrene accounted a fraction of 78 wt % in the block copolymer. The block copolymer was mixed with a certain amount of 4-ethyl-cyclohexanol (diluent) to have a concentration of 22 wt %, then added a certain amount of succinic acid as a pore-forming agent in a molar ratio of 1:1 of carboxylic acid and 4-vinylpyridine. The mixture was heated to 40° C. for dissolving, to obtain a clear and transparent homogeneous solution, and stood at a constant temperature of 40° C. for defoaming, to obtain a bubble free membrane casting solution. As shown in FIG. 2, the membrane casting solution is homogeneous at high-temperature and undergoes phases separation at low-temperature, or is homogeneous at high-temperature and gelates at low-temperature from high temperature to room temperature;
S2: a metal plate was heated to 120.5° C. on a heating stage, and the membrane casting solution with a temperature of 40° C. was poured into a plate frame fixed on the metal plate, and spread to form a membrane by a scraper with a thickness of 300 μm, evaporated at 40° C. for 5 s, sealed with a cover plate, and then transferred to an ice salt water (coolant) with a temperature of −15° C. for cooling for 2 min to initiate the phase separation and gelation; and
S3: the metal plate was taken out from the coolant, the sealing cover plate was opened, the metal plate with a membrane sample was placed in ethanol with a temperature of 21.8° C. for extraction for 30 min, then the sample membrane was placed in deionized water for soaking for 1 h, and took out to fully dry, to obtain an asymmetric isoporous membrane. After the formation of asymmetric isoporous membrane, the mixed solution containing the extracted diluent was subjected to reduced pressure distillation at a temperature of 45° C., to recover solvents of 4-ethyl-cyclohexanol and ethanol for subsequent recycling.

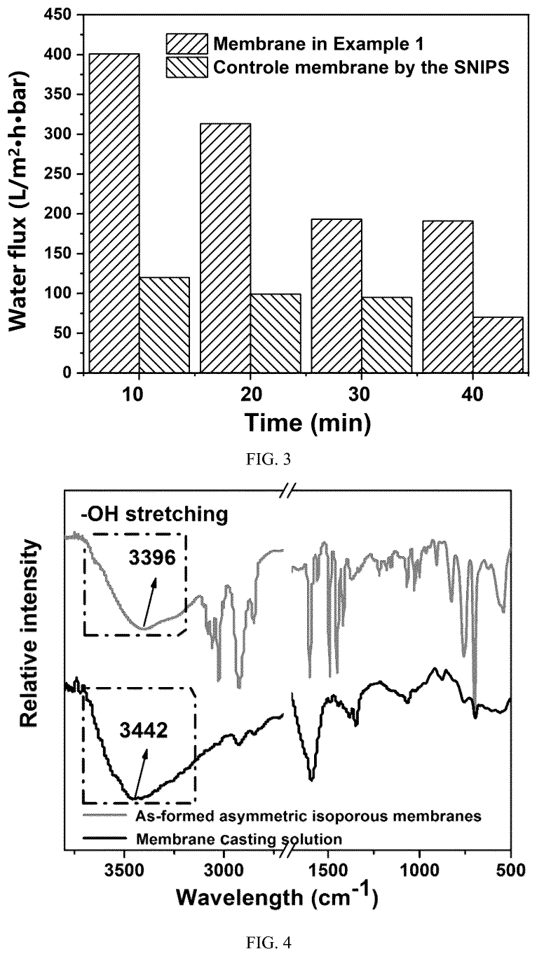

The prepared asymmetric isoporous membrane was placed in an ultrafiltration cell for pure water flux test, and the result was compared with the flux of the membrane prepared by the block copolymer self-assembly combined with non-solvent-induced phase separation (hereafter referred to as SNIPS) using the same block copolymer, as shown in FIG. 3. As seen from the figure, the water flux of the asymmetric isoporous membrane prepared by the present disclosure is 2 times or more of that of the membrane prepared by the block copolymer self-assembly combined with non-solvent-induced phase separation (described as the SNIPS).

As shown in FIG. 4, infrared spectrum measurement was performed for the membrane casting solution before forming membrane and the finally prepared asymmetric isoporous membrane by this example. By referring to the stretching vibrations (3025 and 2925 cm⁻¹) from benzene rings in polystyrene, the asymmetric isoporous membrane had a lower hydroxyl group content than that of the membrane casting solution (—OH stretching at the 3396 and 3342 cm⁻¹), indicating that the diluent cyclohexanol was mostly extracted by the ethanol which serves as the extracting agent in this example.

### Example 2

S1: polystyrene-block-poly (4-vinylpyridine) having a molecular weight of 150,000 g/mol was selected as a block copolymer, where the polystyrene accounted a fraction of 80 wt % in the block copolymer. The block copolymer was mixed with certain amounts of 2-methyl-cyclohexanol and 1,2-cyclohexanediol to have a concentration of 17.5 wt %, where the 2-methyl-cyclohexanol and 1,2-cyclohexanediol had a weight ratio of 6:4, then added a certain amount of adipic acid as a pore-forming agent in a molar ratio of 1.5:1 of carboxylic acid and 4-vinylpyridine. The mixture was heated to 140.6° C. for dissolving, to obtain a clear and transparent homogeneous solution, and stood at a constant temperature of 140° C. for defoaming, to obtain a bubble free membrane casting solution;
S2: a metal plate was heated to 115.5° C. on a heating stage, and the membrane casting solution with a temperature of 140° C. was poured into a plate frame fixed on the metal plate, and spread to form a membrane by a scraper with a thickness of 150 μm, evaporated at 115.5° C. for 30 s, sealed with a cover plate, and then the sealed metal plate was placed in polyethylene glycol 600 with a temperature of 90° C. for cooling for 2 min to initiate the phase separation and gelation; and
S3: the metal plate was taken out from the coolant, the sealing cover plate was opened, the metal plate with a membrane sample was placed in methanol with a temperature of 22.2° C. for extraction for 10 min, then the sample membrane was placed in deionized water for soaking for 1 h, and took out to fully dry, to obtain an asymmetric isoporous membrane. After the formation of asymmetric isoporous membrane, the mixed solution containing the extracted diluent was subjected to reduced pressure distillation at temperatures of 40° C. and 145° C., to recover solvents of 2-methyl-cyclohexanol, 1,2-cyclohexanediol, and methanol for subsequent recycling.

### Example 3

S1: polystyrene-block-poly (4-vinylpyridine) having a molecular weight of 188,000 g/mol was selected as a block copolymer, where the polystyrene accounted a fraction of 80 wt % in the copolymer. The block copolymer was mixed with certain amounts of ethylene glycol monobutyl ether and 1-methyl-cyclohexanol to have a concentration of 35 wt %, where the ethylene glycol monobutyl ether and 1-methyl-cyclohexanol had a weight ratio of 8:2, then added a certain amount of citric acid as a pore-forming agent in a molar ratio of 2:1 of carboxylic acid and 4-vinylpyridine. The mixture was heated to 185° C. for dissolving, to obtain a clear and transparent homogeneous solution, and stood at a constant temperature of 180° C. for defoaming, to obtain a bubble free membrane casting solution;
S2: a polyester non-woven fabric as a membrane support was heated to 120.3° C. on heating stage, and the membrane casting solution with a temperature of 150° C. was poured into a plate frame fixed on the non-woven fabric, spread to form a membrane by a scraper with a thickness of 50 μm, evaporate at 120.3° C. for 7 s, and then the non-woven fabric was placed in air at room temperature for cooling for 2 min to initiate the phases separation and gelation; and
S3: the non-woven fabric with a membrane sample was transferred to petroleum ether with a temperature of 21.2° C. for extraction for 2 min, then the sample membrane was placed in deionized water for soaking for 1 h, and took out to fully dry, to obtain an asymmetric isoporous membrane. After the preparation of the asymmetric isoporous membrane, the mixed solution containing the extracted diluent was subjected to reduced pressure distillation at temperatures of 40° C. and 130° C., to recover solvents of ethylene glycol monobutyl ether, 1-methyl-cyclohexanol, and petroleum ether for subsequent recycling.

### Example 4

S1: polystyrene-block-poly (4-vinylpyridine) having a molecular weight of 210,000 g/mol was selected as a block copolymer, where the polystyrene accounted a proportion of 81 wt % in the copolymer. The block copolymer was mixed with a certain amount of 3-methyl-cyclohexanol to have a concentration of 5 wt %, then added a certain amount of copper acetate as a pore-forming agent in a molar ratio of 2.5:1 of 4-vinylpyridine and copper acetate. The mixture was heated to 165° C. for dissolving, to obtain a clear and transparent homogeneous solution, and stood at a constant temperature of 160° C. for defoaming, to obtain a bubble free membrane casting solution;
S2: a metal plate was heated to 135.5° C. on a heating stage, and the membrane casting solution with a temperature of 160° C. was poured into a plate frame fixed on the metal plate, and spread to form a membrane by a scraper with a thickness of 100 μm, evaporated at 150° C. for 45 s, sealed with a cover plate, and then the sealed metal plate was placed in silicon oil with a temperature of 39° C. for cooling for 2 min to initiate the phases separation and gelation; and
S3: the metal plate was taken out from the coolant, the sealing cover plate was opened, the metal plate with a sample membrane was placed in ethanol with a temperature of 20.2° C. for extraction for 15 min, then the membrane sample was placed in deionized water for soaking for 1 h, and took out to fully dry, to obtain an asymmetric isoporous membrane. After the preparation of the asymmetric isoporous membrane, the mixed solution containing the extracted diluent was subjected to reduced pressure distillation at a temperature of 40° C., to recover solvents of 3-methyl-cyclohexanol and ethanol for subsequent recycling.

### Example 5

S1: polystyrene-block-poly (acrylic acid) having a molecular weight of 300,000 g/mol was selected as a block copolymer, where the polystyrene accounted a proportion of 75 wt % in the copolymer. The block copolymer was mixed with a certain amount of 4-ethyl-cyclohexanol to have a concentration of 10 wt %, then added a certain amount of cyclodextrin as a pore-forming agent in a molar ratio of 1:1 of hydroxyl groups (—OH) and acrylic acid groups (—COOH). The mixture was heated to 135.6° C. for dissolving, to obtain a clear and transparent homogeneous solution, and stood at a constant temperature of 135° C. for defoaming, to obtain a bubble free membrane casting solution;
S2: a polyester non-woven fabric as a membrane support was heated to 85° C. on heating stage, and the membrane casting solution with a temperature of 136° C. was poured into a plate frame which confines the size of non-woven fabric fixed on the heating stage, and spread to form a membrane by a scraper with a thickness of 200 μm, evaporated at 85° C. for 15 s, sealed with a cover plate, and then the sealed plate frame together with fixed non-woven fabric was placed in polyethylene glycol 400 with a temperature of 40.6° C. for cooling for 2 min to induce phase separation and gelation; and
S3: the plate frame together with non-woven fabric was taken out from the coolant, the sealing cover plate was opened, the non-woven fabric with the membrane formed on it was placed in acetone with a temperature of 19.9° C. for extraction for 20 min, then the resultant membrane sample was placed in de-ionized water for soaking for 1 h, and took out to fully dry, to obtain an asymmetric isoporous membrane. After the preparation of the asymmetric isoporous membrane, the mixed solution containing the extracted diluent was subjected to the reduced pressure distillation at temperatures of 40° C. and 150° C., to recover solvents of 4-ethyl-cyclohexanol and acetone for subsequent recycling.

### Example 6

S1: polystyrene-block-poly (ethylene oxide) having a molecular weight of 160,000 g/mol was selected as a block copolymer, where the polystyrene accounted a proportion of 80 wt % in the copolymer. The block copolymer was mixed with certain amounts of 3-methyl-cyclohexanol and 4,4′-bicyclohexanol to have a concentration of 25 wt %, where the 3-methyl-cyclohexanol and 4,4′-bicyclohexanol had a weight ratio of 6:4, then added a certain amount of zinc acetate as a pore-forming agent in a molar ratio of 1:1.5 of zinc ion and ethylene oxide. The mixture was heated to 146.5° C. for dissolving, to obtain a clear and transparent homogeneous solution, and stood at a constant temperature of 145° C. for defoaming, to obtain a bubble free membrane casting solution;
S2: a metal plate as a membrane support was heated to 122.5° C., and the membrane casting solution with a temperature of 145° C. was poured into a plate frame fixed on the metal plate, and scraped to form a membrane by a scraper with a thickness of 250 μm, volatilized at 122.5° C. for 10 s, sealed with a sealing cover plate, and then the sealed metal plate was placed in glycerol with a temperature of 41° C. for cooling for 2 min to separate phases; and
S3: the metal plate was taken out from the coolant, the sealing cover plate was opened, the metal plate with a sample membrane was placed in ethanol with a temperature of 21.2° C. for extraction for 15 min, then the membrane sample was placed in deionized water for soaking for 1 h, and took out to fully dry, to obtain an asymmetric isoporous membrane. After the preparation of the asymmetric isoporous membrane, the mixed solution containing the extracted diluent was subjected to reduced pressure distillation at temperatures of 40° C. and 150° C., to recover solvents of 3-methyl-cyclohexanol, 4,4′-bicyclohexanol, and ethanol for subsequent recycling.

### Example 7

S1: polystyrene-block-poly (2-vinylpyridine) having a molecular weight of 340,000 g/mol was selected as a block copolymer, where the polystyrene accounted a proportion of 75 wt % in the copolymer. The block copolymer was mixed with a certain amount of ethylene glycol monobutyl ether to have a concentration of 20 wt %, then added a certain amount of polyethylene glycol 10000 as a pore-forming agent in a weight ratio of 1:1 of polyethylene glycol and poly (2-vinylpyridine). The mixture was heated to 166° C. for dissolving, to obtain a clear and transparent homogeneous solution, and stood at a constant temperature of 165° C. for defoaming, to obtain a bubble free membrane casting solution;
S2: a metal plate as a membrane support was heated to 145° C., and the membrane casting solution with a temperature of 165° C. was poured into a plate frame fixed on the metal plate, and spread to form a membrane by a scraper with a thickness of 250 μm, evaporated at 145° C. for 7 s, sealed with a sealing cover plate, and then the sealed metal plate was placed in polyethylene glycol 400 with a temperature of 41° C. for cooling for 2 min to induce phase separation; and
S3: the metal plate was taken out from the coolant, the sealing cover plate was opened, the metal plate with a membrane sample was placed in ethanol with a temperature of 22.2° C. for extraction for 2 h, then the membrane sample was placed in deionized water for soaking for 1 h, and took out to fully dry, to obtain an asymmetric isoporous membrane. After the formation of the asymmetric isoporous membrane, the mixed solution containing the extracted diluent was subjected to reduced pressure distillation at a temperature of 40° C., to recover solvents of ethylene glycol monobutyl ether and ethanol for subsequent recycling.

### Example 8

S1: polystyrene-block-poly (4-vinylpyridine) having a molecular weight of 65,000 g/mol was selected as a block copolymer, where the polystyrene accounted a proportion of 73 wt % in the copolymer. The block copolymer was mixed with certain amounts of 4-methyl-cyclohexanol and 1,4-cyclohexanediol to have a concentration of 35 wt %, where the 4-methyl-cyclohexanol and 1,4-cyclohexanediol had a weight ratio of 7:3, then added a certain amount of citric acid as a pore-forming agent in a molar ratio of 1:1.5 of carboxylic acid and 4-vinylpyridine. The mixture was heated to 185° C. for dissolving, to obtain a clear and transparent homogeneous solution, and stood at a constant temperature of 170° C. for defoaming, to obtain a bubble free membrane casting solution;
S2: a metal plate as a membrane support was heated to 165° C., and the membrane casting solution with a temperature of 170° C. was poured into a plate frame fixed on the metal plate, and spread to form a membrane by a scraper with a thickness of 250 μm, evaporated at 165° C. for 7 s, sealed with a sealing cover plate, and then the sealed metal plate was placed in polyethylene glycol 400 with a temperature of 60° C. for cooling for 2 min to initiate the phases separation; and
S3: the metal plate was taken out from the coolant, the sealing cover plate was opened, the metal plate with a membrane sample was placed in isopropanol with a temperature of 22.2° C. for extraction for 2 h, then the membrane sample was placed in de-ionized water for soaking for 1 h, and took out to fully dry, to obtain an asymmetric isoporous membrane. After the preparation of the asymmetric isoporous membrane, the mixed solution containing the extracted diluent was subjected to reduced pressure distillation at a temperature of 40° C., to recover solvents of 4-methyl-cyclohexanol, 1,4-cyclohexanediol, and isopropanol for subsequent recycling.

### Example 9

S1: polystyrene-block-poly (4-vinylpyridine) having a molecular weight of 100,000 g/mol was selected as a block copolymer, where the polystyrene accounted a proportion of 70 wt % in the copolymer. The block copolymer was mixed with certain amounts of 1,3-cyclohexanediol and ethylene glycol monomethyl ether to have a concentration of 35 wt %, where the 1,3-cyclohexanediol and ethylene glycol monomethyl ether had a weight ratio of 5:5, then added a certain amount of magnesium sulfate as a pore-forming agent in a molar ratio of 1:2.5 of magnesium ion and 4-vinylpyridine. The mixture was heated to 135° C. for dissolving, to obtain a clear and transparent homogeneous solution, and stood at a constant temperature of 130° C. for defoaming, to obtain a bubble free membrane casting solution;
S2: a metal plate as a scraped membrane support was heated to 120° C., and the membrane casting solution with a temperature of 130° C. was poured into a plate frame fixed on the metal plate, and spread to form a membrane by a scraper with a thickness of 250 μm, evaporated at 30° C. for 15 s, sealed with a sealing cover plate, and then the sealed metal plate was placed in polyethylene glycol 400 with a temperature of 40° C. for cooling for 2 min to separate phases; and
S3: the metal plate was taken out from the coolant, the sealing cover plate was opened, the metal plate with a sample membrane was placed in ethanol with a temperature of 22.2° C. for extraction for 2 h, then the membrane sample was placed in deionized water for soaking for 1 h, and took out to fully dry, to obtain an asymmetric isoporous membrane. After the formation of the asymmetric isoporous membrane, the mixed solution containing the extracted diluent was subjected to reduced pressure distillation at a temperature of 40° C., to recover solvents of 1,3-cyclohexanediol, ethylene glycol monomethyl ether, and ethanol for subsequent recycling.

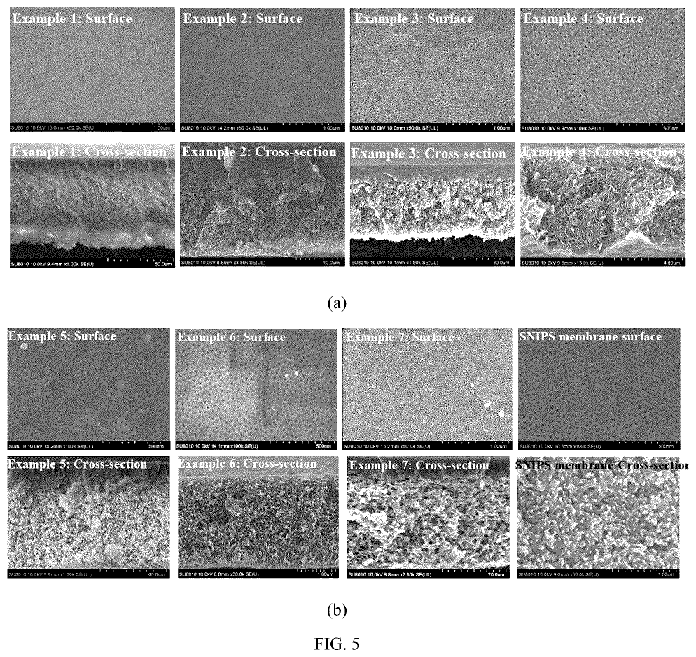

The asymmetric isoporous membranes prepared by Examples 1 to 7 and the SNIPS membrane were tested for scanning electron microscope characterization, to obtain surfaces and cross-section structures as shown in FIG. 5. It can be seen from the figure that the isoporous membranes prepared by the method of the present disclosure have loose cross-section, good permeability, ordered arrangement of surface isoporous structure, and a high porosity. In addition, the isoporous membranes prepared by Examples 1, 4, 6 and 7 have shown better isoporous surface structure and much loose cross-sections, thus a better membrane forming effect.

It can be understood by those skilled in the art that the above description is only preferred examples of the present disclosure and is not intended to limit the present disclosure, although the present disclosure has been described in detail with reference to the above examples, for those skilled in the art, the technical solutions described in the above examples may still be modified, or some technical features thereof may be equivalently replaced. All the modifications, equivalent substitutions and the like made within the spirit and principles of the present disclosure shall fall into the protection scope of the present disclosure.

What is claimed is:

1. A method for preparing a loose cross-sectional asymmetric isoporous membrane based on a thermally induced phase separation process, comprising:
S1: stirring a block copolymer, a diluent, and a pore-forming agent at 40° C. to 185° C. to form a homogeneous membrane casting solution, wherein the block copolymer comprises a hydrophobic chain segment and a hydrophilic chain segment, the hydrophobic chain segment is polystyrene, and the hydrophilic chain segment is a water-soluble polymer or a polymer formed by polymerizing a water-soluble monomer, the diluent is cyclohexanol and/or an ethylene glycol derivative, and the membrane casting solution is phase homogenous at high-temperature and phase separation at low-temperature, or phase homogeneity at high-temperature and gelation at low-temperature;
S2: preheating a porous cloth or a metal plate, evenly spreading the membrane casting solution on the porous cloth or the metal plate, and evaporating the spread solution at 40° C. to 150° C. for 5 s to 45 s, and transferring into a coolant for cooling and gelling; and
S3: immersing a cooled and gelled membrane into an extracting agent for solvent extraction from solid or gelled membrane, and transferring into deionized water for soaking, to obtain the asymmetric isoporous membrane.

2. The method for preparing a loose cross-sectional asymmetric isoporous membrane based on the thermally induced phase separation process according to claim 1, wherein the diluent is any one or a combination of two of cyclohexanol, 1-methyl-cyclohexanol, 2-methyl-cyclohexanol, 3-methyl-cyclohexanol, 4-methyl-cyclohexanol, 4-ethyl-cyclohexanol, 1,2-cyclohexanediol, 1,3-cyclohexanediol, 1,4-cyclohexanediol, 4,4′-bicyclohexanol, ethylene glycol monobutyl ether, and ethylene glycol monomethyl ether.

3. The method for preparing a loose cross-sectional asymmetric isoporous membrane based on a thermally induced phase separation process according to claim 2, wherein when the diluent is a combination of cyclohexanol and 1,2-cyclohexanediol, or a combination of cyclohexanol and 1,3-cyclohexanediol, or a combination of cyclohexanol and 1,4-cyclohexanediol, or a combination of 1-methyl-cyclohexanol and 1,2-cyclohexanediol, or a combination of 1-methyl-cyclohexanol and 1,3-cyclohexanediol, or a combination of 1-methyl-cyclohexanol and 1,4-cyclohexanediol, the 1,2-cyclohexanediol or 1,3-cyclohexanediol or 1,4-cyclohexanediol accounts a proportion of no less than 15 wt % in the diluent.

4. The method for preparing a loose cross-sectional asymmetric isoporous membrane based on a thermally induced phase separation process according to claim 1, wherein the pore-forming agent is any one of adipic acid, succinic acid, citric acid, copper acetate, zinc acetate, magnesium sulfate, cyclodextrin, and polyethylene glycol.

5. The method for preparing a loose cross-sectional asymmetric isoporous membrane based on the thermally induced phase separation process according to claim 1, wherein the coolant is any one of air, water, silicon oil, glycerin, and polyethylene glycol having a molecular weight of no more than 1000 Da, and the coolant has a temperature range of −15° C. to 90° C.

6. The method for preparing a loose cross-sectional asymmetric isoporous membrane based on the thermally induced phase separation process according to claim 1, wherein the extracting agent is any one or a combination of two of isopropanol, acetone, methanol, ethanol, and petroleum ether.

7. The method for preparing a loose cross-sectional asymmetric isoporous membrane based on a thermally induced phase separation process according to claim 1, wherein the block copolymer accounts a mass concentration of 5 wt % to 35 wt % in the membrane casting solution.

8. The method for preparing a loose cross-sectional asymmetric isoporous membrane based on a thermally induced phase separation process according to claim 1, wherein in S2, evenly spreading the membrane casting solution on the porous cloth or the metal plate to a thickness range of 50 μm to 300 μm, and the porous cloth is polyester non-woven fabric or polyolefin non-woven fabric.

9. An asymmetric isoporous membrane prepared by the preparation method according to the claim 1.
